(19) United States
(12) Patent Application Publication
(10) Pub. No.: US 2014/0236898 A1
(43) Pub. Date: Aug. 21, 2014

(54) SYSTEM AND METHOD FOR FACILITATING ELECTRONIC DISCOVERY

(71) Applicant: COMPELLENT TECHNOLOGIES, Eden Prairie, MN (US)

(72) Inventor: Ryan Hankins, St. Paul, MN (US)

(73) Assignee: Compellent Technologies, Eden Prairie, MN (US)

(21) Appl. No.: 13/769,453

(22) Filed: Feb. 18, 2013

(51) Int. Cl. G06F 17/30

(52) U.S. Cl. CPC G06F 17/30088
USPC 707/639

(57) ABSTRACT

A method for facilitating discovery of electronic data stored in a data storage system. The method includes generating a snapshot of the electronic data, wherein the snapshot permits read access to the data, and a copy-on-write technique is used to perform modifications to the data, such that the snapshot is immutable but ongoing user operations with respect to the data can be performed substantially without interruption. The method also includes transmitting data of the snapshot over a network to a data cache server to which an analysis computer system is communicatively coupled. In some embodiments, the data cache server may store a local copy of the transmitted data of the snapshot. In this regard, the data cache server may determine whether data requested by the analysis computer system is stored locally, and if so, the data cache server may transmit the data requested directly to the analysis computer system.

### FIELD OF THE INVENTION

The present disclosure generally relates to systems and methods for facilitating electronic discovery, also referred to as e-discovery. Particularly, the present disclosure relates to systems and methods for efficiently facilitating discovery of electronically stored data in a generally non-disruptive, bandwidth efficient manner, and which may performed over insecure networks while maintaining data security.

### BACKGROUND OF THE INVENTION

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Individuals and businesses also require a certain level of accessibility to the electronic information processed, stored, or otherwise managed in such information handling systems. However, electronic information processed, stored, and otherwise managed by such information handling systems is quite different from paper information because of its intangible form, volume, transience, and persistence, and in the ease in which data can be created, updated, moved, and deleted or erased. In this regard, simple tasks can become increasingly difficult as individuals and businesses grow, and expand the capabilities of, their information handling systems.

For example, electronic discovery or e-discovery, which refers to discovery in a litigation matter that deals with the exchange of information in electronic format, can give rise to issues regarding how such information processed, stored, or otherwise managed in an information handling system is preserved, particularly where the information handling system is large, distributed across a plurality of remote sites, and/or accessed by a large number of users with potentially varying levels of access clearance. Specifically, e-discovery is based on a requirement during litigation to search and turn over electronically stored information for the purpose of the litigation. This process requires individuals and businesses to retain and preserve documents according to specific guidelines and laws in order to properly support the discovery process during litigation. During preservation, data identified as potentially relevant is typically placed on a legal hold for the purpose of ensuring that the data cannot be destroyed, thereby reducing the possibility of data spoliation or destruction. Subsequent analysis, investigation, collection, and production of the data follows as part of the litigation process.

A number of different people can potentially be involved in an e-discovery project, such as, the lawyers for both parties, forensic specialists, IT managers, and records managers. While everyone involved may do their best to understand the e-discovery requirements, potential exists for some data to be destroyed even after a legal hold has been issued, for example, by unknowing technicians performing their regular maintenance duties for the information handling system, by employees of the business performing their ongoing, day-to-day operations, or even automatically by the information handling system itself or some subsystem thereof in carrying out its ongoing, day-to-day administrative actions. To combat such inadvertent destruction of electronic information, many companies deploy policies and/or software which properly preserves data across the information handling system, thereby preventing inadvertent data spoliation. Typically, however, such policies and software require that holds be placed on live data and accessibility thereto be restricted and/or that physical media be taken offline and/or removed from the system (physically or logically), so that it may be copied, during any of which, the data may be inaccessible for extended periods of time (e.g., from several hours up to days at a time).

However, in many companies, as may be appreciated, employees need continuous access to the information handling system and as such, the electronic information stored therein desirably needs to be substantially continually available for access, updating, transferring, and replicating, among other actions. In this regard, the e-discovery process poses substantial complication and risk to the companies' ongoing, day-to-day operations. Likewise, physically copying the data may require extensive labor at the data storage site, which may also put a strain on the companies' resources.

Complicating things further, relatively recent technologies, such as online data storage or cloud-based data storage, which provide virtual storage of data without regard for the physical location of the media, present additional difficulties for the e-discovery process. For instance, although a storage controller can present data from the online storage to users in a manner similar to physical media, data that remains online and available for user modification can often be easily accessed and changed intentionally or inadvertently during the discovery process, thereby diminishing the integrity of the data. As companies move to more cloud-based solutions, the ability to perform ongoing, day-to-day operations remotely, securely, and without the potential for losing data may be increasingly important, especially for larger companies, who must efficiently manage their business data while being subject to legal requirements for preserving that data.

Accordingly, improved systems and methods for facilitating e-discovery are needed, particularly in large data storage systems or information handling systems, or storage and information handling systems that are distributed across a plurality of remote sites. Also what is needed are systems and methods for efficiently and securely facilitating e-discovery over insecure networks while maintaining data security.

### BRIEF SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

The present disclosure, in one embodiment, relates to a method for facilitating discovery of electronic data stored in a data storage system. The method includes generating a snapshot of the electronic data, wherein the snapshot permits read access to the data, and a copy-on-write technique is used to perform modifications to the data, such that the snapshot is immutable but ongoing user operations with respect to the data can be performed substantially without interruption. The method also includes providing access to the snapshot of the electronic data to an analysis computer system. In some embodiments, access to the snapshot is provided over a network, and in further embodiments, the analysis computer system is remote from the data storage system. Providing access to the snapshot may involve transmitting data of the snapshot over the network to a data cache server to which the analysis computer system is communicatively coupled. The data of the snapshot may be transmitted upon request from the data cache server. In some embodiments, to help reduce network traffic, such as for subsequent requests for the data, the data cache server may store a local copy of the transmitted data of the snapshot. In further embodiments, the method may include receiving a request for particular data of the snapshot from the analysis computer system at the data cache server. The data cache server may determine whether the data requested by the analysis computer system is stored locally at the data cache server, and if the data requested by the analysis computer system is stored locally at the data cache server, the data cache server may transmit the data requested by the analysis computer system directly to the analysis computer system, thereby fulfilling the request. However, if the data requested by the analysis computer system is not stored locally at the data cache server, the data cache server may submit a request for the data over the network.

The present disclosure, in another embodiment, relates to an information handling system. The system includes a data storage site having a data storage system and a system controller, the system controller communicatively coupled with the data storage system and managing access to the data storage system by one or more user computer systems. The system controller further manages a snapshot of data of the data storage system, wherein the snapshot permits read access to the corresponding data, and the system controller utilizes a copy-on-write technique to perform modifications to the corresponding data, such that the snapshot is immutable but ongoing input/output (I/O) requests from the one or more user computer systems with respect to the data are performed substantially without interruption. The information handling system also includes an e-discovery site having a data cache server and one or more analysis computer systems communicatively coupled with the data cache server, wherein the system controller and data cache server are communicatively coupled via a computer network. Upon request from the data cache server, the system controller provides access to the snapshot of data. More particularly, upon request from the data cache server, the system controller transmits data of the snapshot over the network. In additional embodiments, the data cache server stores a local copy of the transmitted data of the snapshot. The data cache server is configured to receive requests for particular data of the snapshot from the analysis computer systems. For each request received from the analysis computer systems, the data cache server is configured to determine whether the data requested is stored locally at the data cache server and based on the determination, fulfill the request locally or request data from the system controller.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a schematic of a disk drive system suitable with the various embodiments of the present disclosure.

FIG. 2 is a conceptual diagram of a system for performing e-discovery for a data storage subsystem or information handling system according to one embodiment of the present disclosure.

FIG. 3 is a flow diagram of a method for performing e-discovery for a data storage subsystem or information handling system according to one embodiment of the present disclosure.

### DETAILED DESCRIPTION

The present disclosure relates to novel and advantageous systems and methods for facilitating e-discovery. Particularly, the present disclosure relates to novel and advantageous systems and methods for efficiently facilitating discovery of electronically stored data in a generally non-disruptive, bandwidth efficient manner, and which may securely performed over insecure networks.

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

While the various embodiments are not limited to any particular type of information handling system, the systems and methods of the present disclosure may be particularly useful in the context of a disk drive system, or virtual disk drive system, such as that described in U.S. Pat. No. 7,613,945, titled “Virtual Disk Drive System and Method,” issued Nov. 3, 2009, the entirety of which is hereby incorporated herein by reference. Such disk drive systems allow the efficient storage of data by dynamically allocating user data across a page pool of storage, or a matrix of disk storage blocks, and a plurality of disk drives based on, for example, RAID-to-disk mapping. In general, dynamic allocation presents a virtual disk device or volume to user servers. To the server, the volume acts the same as conventional storage, such as a disk drive, yet provides a storage abstraction of multiple storage devices, such as RAID devices, to create a dynamically sizeable storage device. Data progression may be utilized in such disk drive systems to move data gradually to storage space of appropriate overall cost for the data, depending on, for example but not limited to, the data type or access patterns for the data. In general, data progression may determine the cost of storage in the disk drive system considering, for example, the monetary cost of the physical storage devices, the efficiency of the physical storage devices, and/or the RAID level of logical storage devices. Based on these determinations, data progression may move data accordingly such that data is stored on the most appropriate cost storage available. In addition, such disk drive systems may protect data from, for example, system failures or virus attacks by automatically generating and storing snapshots or point-in-time copies of the system or matrix of disk storage blocks at, for example, predetermined time intervals, user configured dynamic time stamps, such as, every few minutes or hours, etc., or at times directed by the server. These time-stamped snapshots permit the recovery of data from a previous point in time prior to the system failure, thereby restoring the system as it existed at that time. These snapshots or point-in-time copies may also be used by the system or system users for other purposes, such as but not limited to, testing, while the main storage can remain operational. Generally, using snapshot capabilities, a user may view the state of a storage system as it existed in a prior point in time.

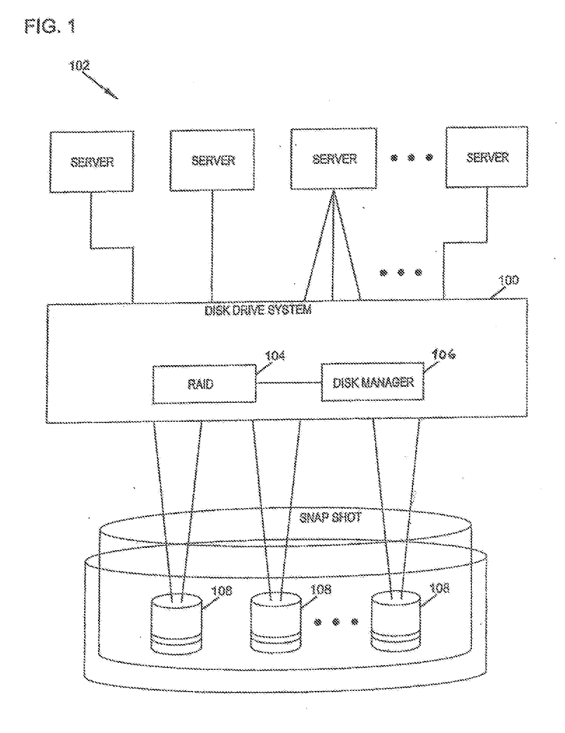

FIG. 1 illustrates one embodiment of a disk drive or data storage system 100 in an information handling system environment 102, such as that disclosed in U.S. Pat. No. 7,613,945, and suitable with the various embodiments of the present disclosure. As shown in FIG. 1, the disk drive system 100 may include a data storage subsystem 104, which may include, but is not limited to, a RAID subsystem, as will be appreciated by those skilled in the art, and a disk manager 106 having at least one disk storage system controller. The data storage subsystem 104 and disk manager 106 can dynamically allocate data across disk space of a plurality of disk drives or other suitable storage devices 108, such as but not limited to optical drives, solid state drives, tape drives, etc., based on, for example, RAID-to-disk mapping or other storage mapping technique. The data storage subsystem 104 may include data storage devices distributed across one or more data sites at one or more physical locations, which may be network connected. Any of the data sites may include original and/or replicated data (e.g., data replicated from any of the other data sites) and data may be exchanged between the data sites as desired.

As will be appreciated by one of skill in the art, the various embodiments of the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, resident software, micro-code, etc.), or an embodiment combining software and hardware aspects. Furthermore, embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. A code segment of the computer-executable program code may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the context of this document, a computer readable medium may be any medium that can contain, store, communicate, or transport the program for use by or in connection with the systems disclosed herein. The computer-executable program code may be transmitted using any appropriate medium, including but not limited to the Internet, wireline, optical fiber cable, radio frequency (RF) signals, or other mediums. The computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device. Computer-readable media includes, but is not to be confused with, computer-readable storage medium, which is intended to cover all physical, non-transitory, or similar embodiments of computer-readable media.

Computer-executable program code for carrying out operations of embodiments of the present disclosure may be written in an object oriented, scripted or unscripted programming language such as Java, Perl, Smalltalk, C++, or the like. However, the computer program code for carrying out operations of embodiments of the present disclosure may also be written in conventional procedural programming languages, such as the C programming language or similar programming languages.

Various embodiments of the present disclosure are described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks. Alternatively, computer program implemented steps or acts may be combined with operator or human implemented steps or acts in order to carry out an embodiment of the invention.

Additionally, although a flowchart may illustrate a method as a sequential process, many of the operations in the flowcharts illustrated herein can be performed in parallel or concurrently. In addition, the order of the method steps illustrated in a flowchart may be rearranged for some embodiments. Similarly, a method illustrated in a flow chart could have additional steps not included therein or fewer steps than those shown. A method step may correspond to a method, a function, a procedure, a subroutine, a subprogram, etc.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an ingredient or element may still actually contain such item as long as there is generally no measurable effect thereof.

As described above, e-discovery, which refers to discovery in a litigation matter that deals with the exchange of information in electronic format, can give rise to issues regarding how such information processed, stored, or otherwise managed in an information handling system is preserved, particularly where the information handling system is large, distributed across a plurality of remote sites, and/or accessed by a large number of users with potentially varying levels of access clearance. Specifically, e-discovery requires individuals and businesses to retain and preserve documents according to specific guidelines and laws in order to properly support the discovery process during litigation. As described above, in a traditional method of combating inadvertent destruction of electronic information, many companies deploy policies and/or software which properly preserves data across the information handling system, thereby preventing inadvertent data spoliation. However, such policies and software often require that holds be placed on live data and accessibility thereto be restricted and/or that physical media be taken offline and/or removed from the system (physically or logically), so that it may be copied, during any of which, the data may be inaccessible for extended periods of time (e.g., from several hours up to days at a time).

Such traditional methods for e-discovery, however, can be detrimental to a companies' ongoing, day-to-day operations, which, as may be appreciated, can require substantially continuous availability to the information handling system and as such, the electronic information stored therein, for the purposes of accessing, updating, transferring, and replicating the data, among other actions. In this regard, traditional e-discovery processes pose substantial complication and risk to the companies' ongoing, day-to-day operations. Online data storage or cloud-based storage, which provide virtual storage of data without regard for the physical location of the media, present further complications for the e-discovery process, in that data that remains online and available for user modification can often be easily accessed and changed intentionally or inadvertently during the discovery process, thereby diminishing the integrity of the data.

The present disclosure improves processes for facilitating e-discovery with respect to data processed, stored, or otherwise managed by a data storage system or other information handling system, such as but certainly not limited to the type of data storage system described in U.S. Pat. No. 7,613,945. The disclosed improvements can provide more efficient facilitation of e-discovery in a generally non-disruptive, bandwidth efficient manner.

In general, in one embodiment of the present disclosure, e-discovery may be performed on data that is generally not subject to change during the discovery process, thereby reducing or eliminating the impact to a companies' ongoing, day-to-day operations or to those of the companies' information handling system. More specifically, in one embodiment, e-discovery may be completed utilizing snapshot data. As described above, an information handling system or disk drive system may automatically generate and store snapshots or point-in-time copies of the system or portions thereof, such as individual volumes or specified disk storage blocks, at, for example, predetermined time intervals, user configured dynamic time stamps, such as, every few minutes or hours, etc., or at times directed by the server. Snapshots may also be taken at user or administrator instruction. While these snapshots or point-in-time copies may be used by the system or system users for any number of purposes, such as but not limited to, recovery after system failure or testing, in general, using snapshot capabilities permits a view of the state of a storage system as it existed at a given prior point in time to be obtained. Importantly, these snapshots may be viewed and utilized in a variety of ways while the information handling system remains operational, or otherwise retains accessibility to system data, including accessibility for modification and/or deletion. In this regard, the various embodiments of the present disclosure can reduce the disruption to ongoing, day-to-day operations caused by the e-discovery process. The immutable snapshot data can be presented to one or more remote sites securely over a network, without losing the integrity of the data or compromising local access to the live system data. Review and analysis may then commence from the remote sites. Because the analysis takes place on immutable snapshot data, the data reviewer, and any system through which the data is transported, is prevented from modifying or altering the data.

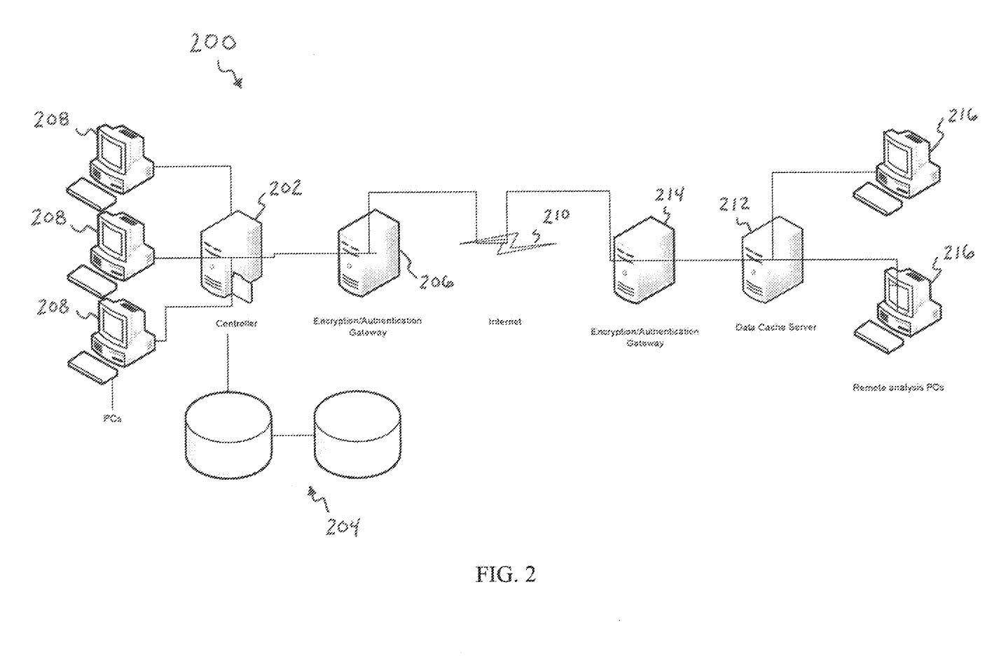

As illustrated more particularly in FIG. 2, in one embodiment, a system 200 for facilitating e-discovery may include a source site having a system controller 202, a data storage subsystem 204, a source gateway device 206, and one or more local user computer systems 208. While the controller, data storage subsystem, source gateway device, and local user computer systems could be, and are illustrated for example as, separate systems, it is recognized that any of the controller, data storage subsystem, source gateway device, and one or more of the local user computer systems could be part of the same system utilizing the same computer hardware. Similarly, although the controller, data storage subsystem, source gateway device, and local user computer systems could be, and are illustrated for example, at a single physical source site, it is recognized that any of the controller, data storage subsystem, source gateway device, and one or more of the local user computer systems could be physically located at the same location or at separate locations and, for example, remotely coupled through a computer network, such as a LAN, WAN, the Internet, etc. The source gateway device 206 may be communicatively coupled with a destination site through a computer network 210, such as a LAN, WAN, the Internet, etc. The destination site may include a data cache server 212, which may also have access to a data storage subsystem or other local storage, a destination gateway device 214, and one or more remote analysis computer systems 216. Again, while the data cache server, destination gateway device, and remote analysis computer systems could be, and are illustrated for example as, separate systems, it is recognized that any of the data cache server, destination gateway device, and one or more of the remote analysis computer systems could be part of the same system utilizing the same computer hardware. Likewise, although the data cache server, destination gateway device, and remote analysis computer systems could be, and are illustrated for example, at a single physical source site, it is recognized that any of the data cache server, destination gateway device, and remote analysis computer systems could be physically located at the same location or at separate locations and, for example, remotely coupled through a computer network, such as a LAN, WAN, the Internet, etc.

The system controller 202, among other things as will be appreciated by those skilled in the art, may generally control access from the local user computer systems 208 to the data storage subsystem 204, which manages the data stored on data storage devices, such as but not limited to one or more disk drives, solid state disks, RAID systems, virtual or online storage devices, or any other suitable storage device now known or later developed. As mentioned above, in some embodiments, the system controller 202 and data storage subsystem 204 may be one and the same, and together can control access to and manage data stored on the data storage devices.

Each local user computer system 208 may be any suitable processing system, including but not limited to, a server, a personal computer, or a smartphone, personal digital assistant, electronic tablet, or other stationary or mobile electronic device capable of communicating with the system controller 202. Furthermore, each local user computer system 208 need not be physically located at a single location, but could each be located at any suitable physical location with capabilities for remotely communicating with the system controller 202. As will be appreciated by those skilled in the art, the local user computer systems 208 may be generally utilized for performing day-to-day operations in the course of normal business.

In one embodiment, benefiting from advantages of copy-on-write techniques, wherein data is copied to a new location before being modified, the system controller 202 and/or data storage subsystem 204 may from time to time generate a snapshot(s) or point-in-time copy(ies) of the system, or a volume(s) or other portion(s) thereof. A snapshot may include a record of write operations to, for example, a volume or other portion of the storage subsystem so that a “view” may subsequently be created to see the contents of the volume or other portion of the storage subsystem as they existed at a given point in time in the past, such as for data recovery, testing, etc. Snapshot capabilities of the system controller 202 and/or data storage subsystem 204 may include, but are not limited to, creating snapshots, managing snapshots, coalescing snapshots, and controlling I/O operations of the snapshots, each of which are described in more detail in U.S. Pat. No. 7,613,945. The copy-on-write and snapshot techniques permit data to be retained in an immutable form while retaining transparent availability to the data for system users for reading and writing at substantially all times.

The system controller 202 may be communicatively coupled with the source gateway device 206, which may further be communicatively coupled with the destination gateway device 214 through the computer network 210. The source gateway device 206 and destination gateway device 214 may each manage encryption/decryption and/or authentication for data transmitted between the source site and destination site over the network 210.

The data cache server 212, among other things as will be appreciated by those skilled in the art, may generally control access from the remote analysis computer systems 216 at the destination site to the data stored at the data cache server and/or at a data storage subsystem accessible thereto, which may be similar to the data storage subsystem 204 described above. Each remote analysis computer system 216, like local user computer systems 208, may be any suitable processing system, including but not limited to, a server, a personal computer, or a smartphone, personal digital assistant, electronic tablet, or other stationary or mobile electronic device capable of communicating with the data cache server 212. Furthermore, each remote analysis computer system 216 need not be physically located at a single location, but could each be located at any suitable physical location with capabilities for remotely communicating with the data cache server 212. For purposes of facilitating e-discovery, the remote analysis computer systems 216 may be utilized to perform review and analysis of electronic documents collected for discovery.

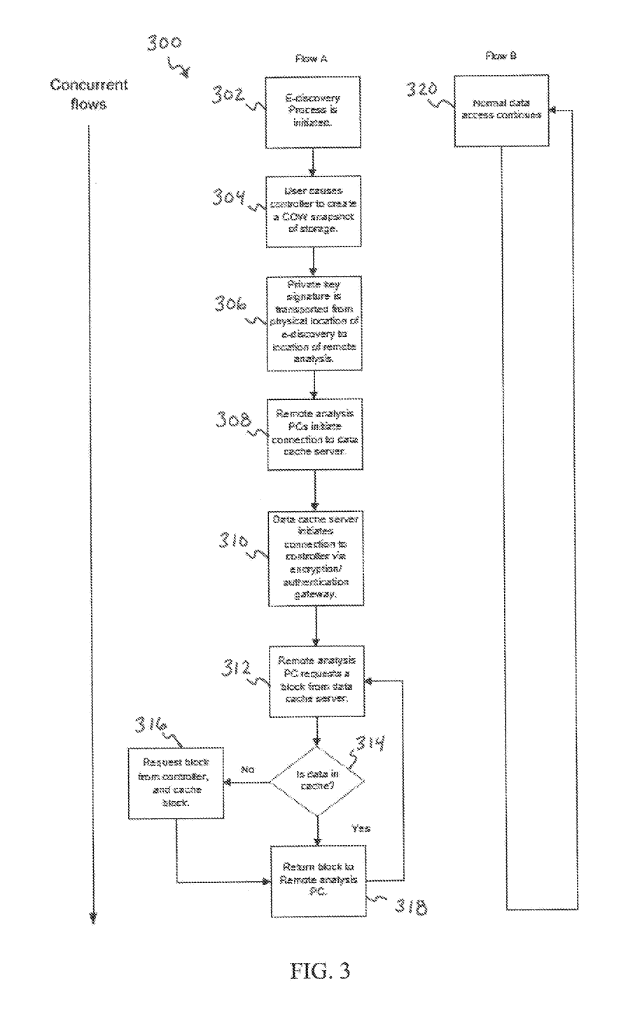

The system operation and interaction between the various components of the system 200 for facilitating e-discovery, and thus a method 300 for facilitating e-discovery according to embodiments of the present disclosure, is described with respect to the flow diagram of FIG. 3. As already stated, while the example method of FIG. 3, and any other method described and illustrated herein, is discussed with respect to certain steps, it is recognized that not every embodiment will include each step illustrated, that some embodiments may include additional steps, and that in other embodiments, the steps may be performed in a different order, and each of such embodiments are considered within the scope of the present disclosure.

In step 302, an e-discovery process may be initiated. The e-discovery, as described above, generally relates to the discovery in a litigation matter that deals with the exchange of information in electronic format. E-discovery is based on a requirement during litigation to search and turn over electronically stored information for the purpose of the litigation, and in accordance with specific guidelines and laws, this process requires individuals and businesses to retain and preserve certain documents. Accordingly, for purposes of discovery, any data identified as potentially relevant is typically placed on a legal hold to ensure that the data cannot be destroyed, purposefully or inadvertently, thereby reducing the possibility of data spoliation or destruction. In this regard, as part of initiating an e-discovery process, an order may be given to place certain data on legal hold.

In step 304, in accordance with the legal hold, an individual may cause or instruct the system controller 202 to generate one or more snapshots of certain specified data. While the individual instructing the system controller 202 to generate the one or more snapshots will typically be a system administrator or other system user, the individual could be any one with the appropriate system clearance or credentials to instruct the system appropriately, and could be any one of a number of potential individuals involved in the e-discovery project, such as but not limited to, a lawyer, forensic specialist, IT manager or other administrator, or records manager. As described above, a snapshot may include a record of write operations to, for example, a volume or other portion of the data storage subsystem 204 so that a “view” may subsequently be created to see the contents of the volume as they existed at a given point in time in the past, such as for data recovery, testing, etc. Copy-on-write and snapshot techniques permit data to be retained in an immutable form while retaining transparent availability to the data for system users for reading and writing at substantially all times. In this regard, the one or more snapshots are not created by copying the selected data of the data storage subsystem, which can use up significant system resources and take up extensive amounts of time during which the data is inaccessible, but instead the existing data blocks stored in the data storage subsystem become immutable, or “frozen,” such that modifications or writes cannot be performed to those blocks directly. Instead, copy-on-write techniques are used to ensure that modifications and writes to the data are performed by copying the existing data to a new location and subsequently performing the modification or write on the data at the new location, thereby leaving the original data undisturbed. In some embodiments, the system controller 202 may perform a cryptographic checksum for the one or more snapshots, or each of the one or more snapshots, and can record, and periodically report, this checksum to ensure that the snapshot data is never altered from its initial, saved or “frozen” state.

In some embodiments, in accordance with step 306, the source gateway device 206 may generate a private or secure key or key signature, which may be utilized to encrypt and decrypt transmitted data and create a secure channel over the network 210, thereby ensuring security and confidentiality of the data transmitted over the network to the destination site. The private key or another similar key may also be utilized to ensure authenticity of the data transmitted over the network 210. Prior to transmitting any data from the source site to the destination site, this key may be transmitted from the source gateway device 206 to the destination gateway device 214. In other embodiments, the private or secure key or key signature may be generated by any other device or an any other suitable manner. For example, and not limited by example, the destination gateway device 214 may generate the private key and transmit the key to the source gateway device 206 or a separate device may generate the private key and transmit the key to both the source gateway device and the destination gateway device. Likewise, any other suitable method of ensuring that both the source gateway device 206 and destination gateway device 214 each have the private key may be utilized. For example, and not limited by example, the private key may be transmitted by any method from one gateway device to another, or from a separate device to the gateway devices, and is not limited to electronic transmission. For example, the private key may be transmitted by standard mailing techniques (e.g., US Mail), may be transferred verbally between administrators at the source and destination sites, may be transferred via flash drives or other portable storage devices, etc. In still another embodiment, the source gateway device 206 and destination gateway device 214 may be communicatively coupled initially having the same private key, which may further prevent man-in-the-middle security attacks.

In step 308, any number of remote analysis computer systems 216 may initiate a connection with the data cache server 212. Likewise, the data cache server, via the destination gateway device 214, may initiate a connection with the system controller 202, via the source gateway device 206 in step 310. In one embodiment, the destination gateway device 214 may utilize the secure key received from the source gateway device 206 to create a secure channel, such as a secure TCP/IP connection utilizing for example but not limited to, IPsec (Internet Protocol Security), SSL (Secure Sockets Layer), TSL (Transport Layer Security), or SSH (Secure Shell), over the network 210 for communication between the controller 202 and data cache server 212. With a secure communication channel created, the data cache server 212 may use an internet protocol or a block-based protocol, such as iSCSI, to communicate with the system controller 202 and access the snapshot from the data storage subsystem 204 via the system controller. In this regard, the remote analysis computer systems 216 may request data as-needed for review and analysis via the data cache server 212.

More specifically, in step 312 any of the remote analysis computer systems 216 may make requests for data, which may be first received by the data cache server 212. For any particular request, in step 314, the data cache server 212 may determine whether such data has already been retrieved from the source site via the controller 202 and is already resident at the data cache server or a local data storage subsystem accessible to the data cache server. If in step 314, it is determined that the data cache server does not currently store the requested data locally, which will generally be the case the first instance one of the remote analysis computer systems 216 make a request for the data, in step 316, the data cache server may request the data from the system controller 202 over the secured network 210. In response to the request from the data cache server 212, the system controller 202 may retrieve the data from the snapshot at the data storage subsystem 204 and transmit the data over the secured network to the data cache server. Upon receipt of the data, in step 218, the data cache server 212 may respond to the initial request from the remote analysis computer system 216 by forwarding the received data on to the remote analysis computer system. The data cache server 212 may also store the data received from the system controller 202 locally, for example, at the data cache server or a local data storage subsystem accessible to the data cache server.

Because the data retrieved from the system controller 202 is immutable, and cannot be changed, the data cache server 212 need only request and retrieve data from the system controller the first time such data is requested by a user computer system 216. As indicated above, after the initial request, the data cache server 212 may store the data received from the system controller 202 locally. In this regard, in response to subsequent requests for the same data, the data cache server 212 may retrieve the data locally rather than requesting the data through the network 210. For example, if in step 314, subsequent a remote analysis computer systems 216 request for data, it is determined that the data cache server does indeed currently store the requested data locally, then the data cache server may skip step 316, and in step 318, may respond directly to the request from the remote analysis computer system 216 with the locally stored data. Local storage by the data cache server can reduce network traffic and bandwidth usage, thereby increasing bandwidth availability for other network traffic and system operations.

As will be recognized in FIG. 3, normal data access 320 to the data storage subsystem 204 by the local user computer systems 208, such as for ongoing, day-to-day operations, may continue concurrently during the e-discovery process substantially without interruption. Indeed, data access by the remote analysis computer systems 216 may, in most embodiments, be transparent to the local user computer systems 208, and vice versa, and both the local user computer systems 208 and remote analysis computer systems 216 can proceed without disturbing the data security and integrity and without compromising local access to the system controller 202 and the data storage subsystem 204.

The various embodiments of the present disclosure relating to systems and methods for facilitating e-discovery provide significant advantages over conventional systems and methods for facilitating e-discovery, which involve policies and/or software requiring that holds be placed on live data and accessibility thereto be restricted and/or that physical media be taken offline and/or removed from the system (physically or logically), so that it may be copied, during any of which, the data may be inaccessible for extended periods of time (e.g., from several hours up to days at a time). More specifically, the various embodiments of the present disclosure may permit e-discovery to be performed securely at remote locations, without compromising local access to the data. In general, the various embodiments of the present disclosure permit efficient discovery of electronically stored data in a generally non-disruptive, bandwidth efficient manner, which may performed over insecure networks while maintaining data security.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

We claim:

1. A method for facilitating discovery of electronic data stored in a data storage system, the method comprising:
generating a snapshot of the electronic data, wherein the snapshot permits read access to the data, and a copy-on-write technique is used to perform modifications to the data, such that the snapshot is immutable but ongoing user operations with respect to the data can be performed substantially without interruption; and
providing access to the snapshot of the electronic data to an analysis computer system.

2. The method of claim 1, wherein providing the access to the snapshot is provided over a network.

3. The method of claim 2, wherein the analysis computer system is remote from the data storage system.

4. The method of claim 2, wherein providing the access to the snapshot comprises transmitting data of the snapshot over the network to a data cache server to which the analysis computer system is communicatively coupled.

5. The method of claim 4, wherein the data of the snapshot is transmitted upon request from the data cache server.

6. The method of claim 5, further comprising storing a local copy of the transmitted data of the snapshot at the data cache server.

7. The method of claim 4, further comprising generating a security key required for accessing the snapshot data and transmitting the security key to the data cache server.

8. The method of claim 4, wherein transmitting data of the snapshot over the network comprises transmitting the data utilizing a block-based protocol.

9. The method of claim 6, further comprising receiving a request for particular data of the snapshot from the analysis computer system at the data cache server.

10. The method of claim 9, further comprising determining whether the data requested by the analysis computer system is stored locally at the data cache server and if the data requested by the analysis computer system is stored locally at the data cache server, transmitting the data requested by the analysis computer system from the data cache server to the analysis computer system.

11. The method of claim 10, wherein if the data requested by the analysis computer system is not stored locally at the data cache server, transmitting data of the snapshot, corresponding to the data requested by the analysis computer system, over the network to the data cache server.

12. The method of claim 11, further comprising encrypting the data of the snapshot for transmission over the network.

13. An information handling system comprising:
a data storage site comprising a data storage system and a system controller, the system controller communicatively coupled with the data storage system and managing access to the data storage system by one or more user computer systems, the system controller further managing a snapshot of data of the data storage system, wherein the snapshot permits read access to the corresponding data, and the system controller utilizes a copy-on-write technique to perform modifications to the corresponding data, such that the snapshot is immutable but ongoing input/output (I/O) requests from the one or more user computer systems with respect to the data are performed substantially without interruption; and
an e-discovery site comprising a data cache server and one or more analysis computer systems communicatively coupled with the data cache server, wherein the system controller and data cache server are communicatively coupled via a computer network;
wherein, upon request from the data cache server, the system controller provides access to the snapshot of data.

14. The information handling system of claim 13, wherein the system controller and data cache server are remotely connected via the computer network.

15. The information handling system of claim 14, wherein, upon request from the data cache server, the system controller transmits data of the snapshot over the network.

16. The information handling system of claim 15, wherein the data cache server stores a local copy of the transmitted data of the snapshot.

17. The information handling system of claim 14, wherein the data cache server is configured to receive requests for particular data of the snapshot from the one or more analysis computer systems.

18. The information handling system of claim 17, wherein, for each request received from the one or more analysis computer systems, the data cache server is configured to determine whether the data requested is stored locally at the data cache server and based on the determination, fulfill the request locally or request data from the system controller.

19. The information handling system of claim 17, wherein data transmitted by the system controller is encrypted.

20. The information handling system of claim 17, wherein data transmitted by the system controller follows a block-based protocol.
